(19) United States
(12) Patent Application Publication
(10) Pub. No.: US 2025/0208373 A1
(43) Pub. Date: Jun. 26, 2025

(54) AUTOFOCUS CAMERA STRUCTURE

(71) Applicants: YIBIN TINNO COMMUNICATION CO. LTD, Yibin City, Sichuan (CN); SHENZHEN TINNO WIRELESS TECHNOLOGY CO., LTD, Shenzhen, Guangdong (CN)

(72) Inventor: Suiliang TAN, Shanghai (CN)

(21) Appl. No.: 18/850,049

(22) PCT Filed: Jan. 4, 2023
(86) PCT No.: PCT/CN2023/070252

§ 371 Date: Sep. 23, 2024

(30) Foreign Application Priority Data
Dec. 31, 2022 (CN) 202211737868.0

(51) Int. Cl. G02B 7/09; G02B 7/02; G03B 3/10

(52) U.S. Cl. CPC G02B 7/09; G02B 7/027; G03B 3/10

(57) ABSTRACT

The present invention relates to the technical field of camera equipment, in particular to an autofocus camera structure for cell phone applications, comprising a glass substrate, and a deformed glass plate having an image-side surface is provided on one side of the glass substrate, wherein a polymer resin layer supporting the image-side surface of the deformed glass plate is provided between the glass substrate and the deformed glass plate, so as to form a converging lens among the glass substrate, the polymer resin layer, and the deformed glass plate; and a piezoelectric thin film ring is provided around the image-side surface to realize a change of focus by deformation generated by the piezoelectric thin film ring.

### TECHNICAL FIELD

The present invention relates to the technical field of camera devices, and in particular to an autofocus camera structure for cell phone applications.

### BACKGROUND ART

With the rapid development of the cell phone industry, people are increasingly demanding the volume of cell phone product modules. At present, more and more cell phone front camera, front camera design program is very much, based on the cell phone structure industrial design trend of ultra-thin ultra-small demand, while taking into account the automatic focus (AF) function, to achieve a clear picture of different distances, the traditional way need to use the voice coil motor (VCM) to drive the lens to focus the action, due to the large size of the VCM, resulting in the thickness of the whole machine as well as the size of the larger.

For example, full-screen cell phones on the market today require the front camera to be as small as possible. However, in the current design, the driver chip and memory chip are separated from the voice coil motor set at the lens, or even set on the circuit board outside the lens, and the driver chip is electrically connected to the voice coil motor to drive the lens movement. The size of the camera module is too large, which is not conducive to reducing the size of the whole camera. In addition, the voice coil motor has a magnet and iron frame, which is easy to produce electromagnetic interference with the surrounding electronic devices, affecting the electronic shielding performance of the phone. Moreover, in VCM autofocus technology, the voice coil motor that moves the lens is affected by gravity and inertia, which can cause vibration effects, affecting the speed and stability of focusing.

### CONTENT OF THE INVENTION

In view of the above drawbacks of the prior art, it is an object of the present invention to provide an autofocus camera structure, and to provide a camera structure that effectively reduces the size to achieve miniaturization and at the same time possesses an autofocus (AF) function.

In order to achieve the above object, the present application provides an autofocus camera structure characterized in that it comprises: an autofocus camera structure comprising a glass substrate, and a deformed glass plate having an image-side curved surface is provided on one side of the glass substrate, wherein a polymer resin layer supporting an image-side curved surface of the deformed glass plate is provided between the glass substrate and the deformed glass plate to enable the glass substrate, the polymer resin layer and the deformed glass plate to form a converging lens; and a piezoelectric thin film ring is provided around the image-side curved surface of the deformed glass plate to realize a change in focal length by deformation generated by the piezoelectric thin film ring.

Further, the middle region of the deformed glass plate forms an image-side curved surface away from the glass substrate.

Further, the piezoelectric thin film ring is located on the other side of the deformed glass plate away from the polymer resin layer.

Further, the piezoelectric thin film ring is deformed by applying a voltage, and pressure is applied by utilizing this deformation to change the curvature of the image-side curved surface of the deformed glass plate, realizing a change in focal length.

Further, the deformed glass plate is made of transparent Plexiglass.

Further, the soft organic glass is any one of thermoplastic elastomer (TPE), polyethylene terephthalate (PET) or polyvinyl chloride (PVC).

Further, the piezoelectric thin film ring is a piezoelectric actuator, subject to a voltage-controlled deformation state in a direction perpendicular to the surface of the glass substrate, for controlling the upward and downward displacements around the deformed glass plate in a direction perpendicular to the surface of the glass substrate to change the curvature of the image-side curved surface of the deformed glass plate.

Further, the polymer resin layer is used to support the spacing between the center of the image-side curved surface of the deformed glass plate and the glass substrate when the curvature of the image-side curved surface of the deformed glass plate is changed.

Further, the polymer resin includes one or more of alkyd resins off, amino resins, nitro resins, cellulose resins, perchloroethylene resins, vinyl resins off, acrylic resins, polyester resins, epoxy resins, urethane resins, silicone resins, and rubber.

Further, said glass substrate surface is vaporized with a layer of In₂O₃ or SnO₂ transparent conductive layer.

As mentioned above, in the design of cell phones, there is a very strong demand for miniaturization of the camera module due to the limitation of the operating space; due to the limitation of the pixel size and aperture of the photoreceptor chip, the depth of field of the imaging are relatively limited. This application is an autofocus camera structure that can well solve this problem. This application utilizes a deformation glass plate and a piezoelectric thin film ring to realize the miniaturization of the focusing camera and at the same time have the automatic focusing (AF) function. On the basis of an existing fixed focus camera module, a deformation glass plate is assembled, and a piezoelectric thin film is deformed by applying an adjustable voltage around the deformation glass plate to adjust the curvature of the deformation glass plate and change the focal length of the lens of the module, thus realizing the function of AF and miniaturizing the size of the camera module in the XY direction at the same time.

### BRIEF DESCRIPTION OF THE DRAWINGS

FIG. 1 shows a cross-sectional schematic diagram of the autofocus camera structure of the present application.

### DETAILED DESCRIPTION OF THE EMBODIMENTS

The technical solutions in the embodiments of the present application will be described clearly and completely in the following in conjunction with the accompanying drawings in the embodiments of the present application, and it is obvious that the described embodiments are a part of the embodiments of the present application, not all of the embodiments. Based on the embodiments in this application, all other embodiments obtained by a person of ordinary skill in the art without creative labor fall within the scope of protection of this application.

It should be noted that the structure, proportion, size, etc. shown in the drawings attached to this specification are only used to match the content of the specification for people familiar with the technology to understand and read, and are not used to limit the implementation of the present invention, so they do not have the technical significance of the modification of the structure, the proportion of the relationship between the changes in the size of the adjustments, without affecting the efficacy of the present invention and the purpose of the invention, should still fall within the scope of this application. Meanwhile, the terms such as “top”, “bottom”, “left”, “right”, “center” and “first”, “second”, etc. cited in this specification are only for the convenience of narrative clarity and are not intended to limit the scope of the implementable invention, changes or adjustments in their relative relationships are considered to be within the scope of the present invention without substantially changing the technical content.

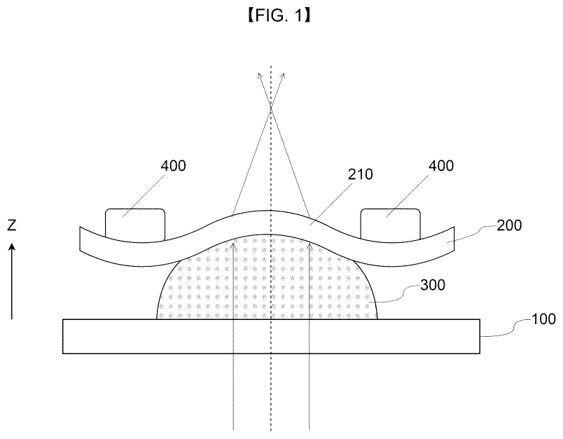

Please refer to FIG. 1 for a sectional schematic diagram of the autofocus

camera structure of the present application. Applied to the front cell phone camera based on the cell phone structure industrial design of ultra-thin ultra-miniaturization demand trend, while taking into account the automatic focus (AF) function, to achieve a clear picture taken at different distances. The autofocus camera structure of the present application, comprising: a glass substrate 100, and a deformed glass plate 200 having an image-side curved surface 210 provided on one side of the glass substrate 100, wherein a polymer resin layer 300 supporting the image-side curved surface 210 of said deformed glass plate 200 is provided between said glass substrate 100 and said deformed glass plate 200, so that said glass substrate 100, said polymer resin layer 300 and said deformed glass plate 200 form a converging lens; and a piezoelectric thin film ring 400 is provided around the image-side curved surface 210 of said deformed glass plate 200 so as to realize the change of focal length by the deformation generated by said piezoelectric thin film ring 400.

As a preference of this embodiment, the glass substrate 100 has a layer of In₂O₃ or SnO₂ transparent conductive layer vaporized on the surface of the glass substrate 100, and when further preferred, the application may be a general transparent glass.

In this embodiment, a deformed glass plate 200, said deformed glass plate 200 is located on one side of said glass substrate 100, and the middle region of said deformed glass plate 200 forms an image-side surface 210 away from said glass substrate 100; said image-side surface 210 corresponds to a photoreceptor chip in the cellular phone (not shown in the figure).

When this embodiment is applied, said deformation glass plate 200 is made of transparent Plexiglas.

As a preferred embodiment, the material of the deformation glass plate 200 is selected from one of thermoplastic elastomer (TPE), polyethylene terephthalate (PET) or polyvinyl chloride (PVC).

In this embodiment, the polymer resin layer 300 is located between said glass substrate 100 and said deformed glass plate 200, supporting the image-side curved surface 210 of said deformed glass plate 200 to project to the light-sensitive chip in the cellular phone, so that the said glass substrate 100, the said polymer resin layer 300, and the said deformed glass plate 200 form a converging lens, so that after the parallel light is refracted by the formed converging lens, the light will converge at one point to focus on the light-sensitive chip in the cellular phone, realizing the purpose of taking clear pictures at different distances.

When this embodiment is applied, the polymer resin layer 300 is elastic and supports said deformed glass plate 200 and maintains the state of the image-side curved surface 210 of said deformed glass plate 200 at normal times. Said polymer resin layer 300 is made of transparent material selected from one of thermoplastic elastomer (TPE), polyethylene terephthalate (PET) or polyvinyl chloride (PVC).

In this embodiment, the polymer resin layer 300 has an indeterminate but usually high relative molecular weight, and is a solid, medium solid, pseudo-solid, and sometimes liquid organic substance at room temperature. It has a softening or melting temperature range, has a tendency to flow under external force, and is often shell-like when ruptured.

This embodiment is preferred for polyethylene terephthalate, has excellent physical and mechanical properties in a wide range of temperatures, the use of temperature up to 120° C., excellent electrical insulation, even at high temperatures and high frequencies, its electrical properties are still good, but corona resistance is poor, creep resistance, fatigue resistance, friction resistance, dimensional stability are very good.

As a preferred embodiment, the piezoelectric thin film ring 400 is disposed on the other side of said deformation glass plate 200 away from said polymer resin layer 300, and said piezoelectric thin film ring 400 surrounds the image-side curved surface 210 of said deformation glass plate 200; the piezoelectric thin film ring 400 is deformed by the application of a voltage, and the pressure is applied to change the curvature of the image-side curved surface of the deformation glass plate by utilizing the deformed state to change the focal length of the image-side curved surface.

In this embodiment, the piezoelectric thin film ring 400 is a piezoelectric actuator, and said piezoelectric thin film ring 400 is subjected to a voltage-controlled deformation state in a direction perpendicular (Z-axis direction) to the surface of said glass substrate for controlling the periphery of said deformable glass plate 200 to be shifted up and down (Z-axis direction) in a direction perpendicular to the surface of said glass substrate for altering the curvature of the image-side curved surface 210 of said deformable glass plate 200.

Piezoelectric thin film ring 400 of this embodiment by stretching or bending a piece of piezoelectric polyvinylidene fluoride PVDF polymer film (piezoelectric thin film), an electrical signal (charge or voltage) is generated between the upper and lower electrode surfaces of the film and is proportional to the deformation of the stretching or bending. Piezoelectric materials in general are sensitive to pressure, but in the case of piezoelectric thin films, a very small force applied in the longitudinal direction produces a large stress in the transverse direction, whereas if the same force is applied over a large area of the film, the resulting stress is much smaller. Piezoelectric thin films are therefore very sensitive to dynamic stress, with typical sensitivity values of 10 to 15 mV/microstrain (parts per million change in length) for 28 μm thick PVDF.

In this embodiment, said polymer resin layer 300 is used to support the spacing between the center of said image-side curved surface 210 of said deformed glass plate 200 and said glass substrate 100 when the curvature of said image-side curved surface 210 of said deformed glass plate 200 changes.

The technical features of the present application are to provide an autofocus camera structure, and to provide a camera structure which effectively reduces the size to realize miniaturization and at the same time has an autofocus (AF) function. Pressure is applied by a piezoelectric thin film ring 400 around the periphery of said deformed glass plate 200 to change the curvature of said deformed glass plate 200, realizing a change in the focal length of the whole set of converging lenses, instead of applying a current to two pins of a voice coil motor shrapnel in a conventional way to control the lens to realize the focusing process;

In cell phone design due to the limitations of the pixel size and aperture of the sensor chip, the depth of field of imaging are limited. The present application is an autofocus camera structure that can well solve this problem. The present application utilizes a deformation glass plate and a piezoelectric thin film ring to realize the miniaturization of the focusing camera and at the same time to have the automatic focusing (AF) function. On the basis of an existing fixed focus camera module, a deformation glass plate is assembled, and a piezoelectric thin film is deformed by applying an adjustable voltage around the deformation glass plate to adjust the curvature of the deformation glass plate and change the focal length of the lens of the module, thus realizing the function of AF and miniaturizing the size of the camera module in the XY direction at the same time.

The above-described embodiments are only used to illustrate the technical solutions of the present application and are not intended to be a limitation thereof; notwithstanding the detailed description of the present application with reference to the foregoing embodiments, it should be understood by those of ordinary skill in the art: it is still possible to modify the technical solutions documented in the preceding embodiments, or to make equivalent substitutions for some of the technical features therein; these modifications or substitutions do not detach the essence of the corresponding technical solutions from the spirit and scope of the technical solutions of the embodiments of the present application, and shall be included in the scope of protection of the present application, and all equivalent modifications or alterations made by persons with ordinary knowledge in the technical field of the subject matter of the present application without detaching from the spirit and technical ideas disclosed herein, shall still be covered by the claims of the present application.

What is claimed is:

1. An autofocus camera structure, characterized in that it includes a glass substrate, and a deformation glass plate having a like-side surface is provided on one side of the glass substrate, wherein the glass substrate and the deformation glass plate are provided with a polymer resin layer supporting an image-side surface of the deformation glass plate, so as to form a converging lens between the glass substrate, the polymer resin layer, and the deformation glass plate; and a piezoelectric thin film ring is provided around the image-side surface of the deformation glass plate, so as to realize a change of a focal length by deformation generated by the piezoelectric thin film ring.

2. The autofocus camera structure of claim 1, characterized in that the middle region of the deformation glass plate forms an image-side curved surface away from the glass substrate.

3. The autofocus camera structure of claim 1, characterized in that the piezoelectric thin film ring is located on the other side of the deformation glass plate away from the polymer resin layer.

4. The autofocus camera structure of claim 3, characterized in that the piezoelectric thin film ring is deformation by applying a voltage, and this deformation is used to apply pressure to change the curvature of the image-side curved surface of the deformation glass plate to achieve a change in focal length.

5. The autofocus camera structure of claim 1, characterized in that the material of the deformation glass plate is a transparent organic soft glass.

6. The autofocus camera structure of claim 5, characterized in that the Plexiglass is any one of a thermoplastic elastomer (TPE), a polyethylene terephthalate (PET), or a polyvinyl chloride (PVC).

7. The autofocus camera structure of claim 1, characterized in that the piezoelectric thin film ring is a piezoelectric actuator subject to a voltage controlled deformation state in a direction perpendicular to the surface of the glass substrate for controlling the up and down displacement around the deformation glass plate in a direction perpendicular to the surface of the glass substrate to change the curvature of the image-side curvature of the image-side curved surface of the deformation glass plate.

8. The autofocus camera structure of claim 1, characterized in that the polymer resin layer is used to support the spacing between the center of the image-side surface of the deformation glass plate and the glass substrate when the curvature of the image-side surface of the deformation glass plate is changed.

9. The autofocus camera structure of claim 1, characterized in that the polymer resin comprises one or more of alkyd resins off, amino resins, nitro resins, cellulose resins, perchloroethylene resins, vinyl resins off, acrylic resins, polyester resins, epoxy resins, urethane resins, silicone resins, and rubber.

10. The autofocus camera structure of claim 1, characterized in that the surface of the glass substrate is vaporized with a transparent conductive layer of In₂O₃ or SnO₂.
